(19) United States
(12) Patent Application Publication
(10) Pub. No.: US 2008/0215330 A1
(43) Pub. Date: Sep. 4, 2008

(54) Audio Signal Modification

(75) Inventors: Aki Sakari Harma, Eindhoven (NL); Albertus Cornelis Den Brinker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,364

(22) PCT Filed: Jul. 18, 2006
(86) PCT No.: PCT/IB06/52450

§ 371 Date: Jan. 22, 2008

(30) Foreign Application Priority Data
Jul. 21, 2005 (EP) 05106686.8
Oct. 5, 2005 (EP) 05109221.1

(51) Int. Cl. G10L 13/00

(52) U.S. Cl. 704/265; 704/258; 704/E13.001

(57) ABSTRACT

A method of modifying an audio signal comprises the steps of analyzing the input audio signal (x) so as to produce a set of filter parameters (p) and a residual signal (r), modifying the set of filter parameters (p) so as to produce a modified set of filter parameters (p′), and synthesizing an output audio signal (y) using the modified set of filter parameters (p′) and the residual signal (r). The set of filter parameters (p) comprises poles (λ_{A}) and coefficients (a; c). The step of modifying the filter parameters (p) involves interpolating lattice filter reflection coefficients (c) so as to scale the spectral envelope of the audio signal.

The present invention relates to audio signal modification. More in particular, the present invention relates to a method and a device for the frequency axis modification of the spectral envelope of audio signals, such as speech signals.

It is known to modify the frequency distribution of an audio signal. In some applications, it is desired to change the frequency scale of a signal, for example in voice modification systems. By scaling the frequency axis, the formants of a speech signal may be shifted so as to change the perception of the speech signal. However, conventional scaling methods are cumbersome as they involve many parameters which have to be set correctly to obtain the desired result. In addition, these scaling methods typically involve extensive computations.

In addition to (linear) scaling, the frequency axis may be subjected to a non-linear transformation, that is, non-linear scaling. Non-linear scaling of the frequency axis is often referred to as (frequency) warping. Conventional warping techniques are computationally complex.

An example of a Prior Art frequency axis modification technique is disclosed in U.S. Pat. No. 5,930,753 (AT&T, Potamianos). This Prior Art technique combines frequency warping and spectral shaping in speech recognition based upon hidden Markov models. Speech utterances are compensated by simultaneously scaling the frequency axis and reshaping the spectral energy contour. To optimize warping factors, computationally burdensome maximum likelihood techniques are used.

It is an object of the present invention to overcome these and other problems of the Prior Art and to provide a method and a device for modifying an audio signal, in particular frequency axis modification of the spectral envelope of an audio signal, such as a speech signal, which are relatively simple and involve a smaller number of control parameters.

Accordingly, the present invention provides a method of modifying an audio signal, the method comprising the steps of:

analyzing the audio signal so as to produce a set of filter parameters and a residual signal, the set of filter parameters comprising poles and coefficients,

modifying one or more filter parameters so as to produce a modified set of filter parameters, and

synthesizing a modified audio signal using the modified set of filter parameters and the residual signal,

wherein the step of modifying one or more filter parameters involves interpolating lattice filter reflection coefficients so as to scale the spectral envelope of the audio signal.

By modifying lattice filter coefficients by interpolation, as the case may be, the spectral envelope of the audio signal can be scaled very efficiently. That is, the scaling (interpolation) of filter coefficients in order to scale the spectral envelope of the audio signal can be carried out with a minimal computational effort if the filter coefficients are the coefficients of a lattice filter, typically called reflection coefficients. The interpolation of the lattice filter coefficients takes place over the index number of the parameters, the index number indicating the order of the coefficients in the filter.

It is noted that lattice filters are well known per se, but that their very advantageous properties for scaling audio signals have not been recognized before the present invention was made. Lattice filters allow a simple transformation to effect a scaling of the spectral envelope. In contrast, Prior Art methods involve complex calculations, such as determining the autocorrelation function of a filter, scaling the time axis of the autocorrelation function, and deriving the modified filter parameters from the scaled autocorrelation function. Such Prior Art methods have a high computational complexity, while other Prior Art methods suffer from filter instability problems.

In the method of the present invention, the step of analyzing may produce a set of regular filter coefficients (e.g. the coefficients of a so-called direct form filter) which are subsequently transformed into lattice filter reflection coefficients. In a preferred embodiment of the present invention, however, the step of analyzing the audio signal involves producing lattice filter reflection coefficients. That is, the reflection coefficients are produced directly, without a prior step of producing regular filter coefficients. The step of analyzing the audio signal and producing a set of filter parameters and a residual signal preferably uses a lattice filter, as this lattice filter will be able to use the directly produced reflection coefficients to produce the residual signal.

Similarly, it is preferred that the step of synthesizing a modified audio signal involves using modified lattice filter reflection coefficients. That is, the synthesis filter preferably is a lattice filter. This avoids the intermediary step of converting lattice filter reflection coefficients into regular filter coefficients.

In the method of the present invention the step of modifying one or more filter parameters may advantageously involve modifying poles so as to warp the spectral envelope of the audio signal. In this manner, both scaling and warping can be carried out, thus achieving both a linear and a non-linear transformation of the spectral envelope of the audio signal, in the direction of the frequency axis of the spectral envelope.

The step of modifying poles so as to warp the spectral envelope of the audio signal may also be carried out independently, without the step of scaling the spectral envelope. Accordingly, the present invention also provides a method of modifying an audio signal, the method comprising the steps of:

analyzing the audio signal so as to produce a set of filter parameters and a residual signal, the set of filter parameters comprising poles and coefficients,

modifying one or more filter parameters so as to produce a modified set of filter parameters, and

synthesizing a modified audio signal using the modified set of filter parameters and the residual signal,

wherein the step of modifying one or more filter parameters involves modifying poles so as to warp the spectral envelope of the audio signal.

If the method of the present invention includes warping, it is preferred that the step of modifying one or more filter parameters involves replacing at least some poles (λ_{A}) with a modified pole (λ_{B}), where the modified pole is given by

$${λ}_{B} = \frac{μ + {λ}_{A}}{1 + μ \cdot {λ}_{A}} ,$$

and where μ is a warping parameter.

In addition to modifying the (spectral) envelope of the audio signal, the residual signal may also be modified to achieve further audio signal modifications. More in particular, the method of the present invention may further comprise the step of modifying the frequency and/or the phase of the residual signal.

The present invention further provides a computer program product for carrying out the method as defined above. A computer program product may comprise a set of computer executable instructions stored on a data carrier, such as a CD or a DVD. The set of computer executable instructions, which allow a programmable computer to carry out the method as defined above, may also be available for downloading from a remote server, for example via the Internet.

The invention may be implemented in software, as mentioned above, or in hardware. Suitable hardware embodiments may include an Application-Specific Integrated Circuit (ASIC), or a programmable logic circuit, such as a Field Programmable Gate Array (FPGA).

The present invention additionally provides a device for modifying an audio signal, the device comprising:

an analysis unit for analyzing the audio signal so as to produce a set of filter parameters and a residual signal, the set of filter parameters comprising poles and coefficients,

a modification unit for modifying one or more filter parameters so as to produce a modified set of filter parameters, and

a synthesis unit for synthesizing a modified audio signal using the modified set of filter parameters and the residual signal,

wherein the modification unit is arranged for interpolating lattice filter reflection coefficients so as to scale the envelope of the audio signal.

In the device of the present invention, the analysis unit is preferably arranged for producing lattice filter reflection coefficients. Accordingly, the analysis filter may comprise a lattice filter, or may comprise a regular (e.g. tapped line) filter and a conversion unit for converting regular filter coefficients into lattice filter reflection coefficients. In alternative embodiment, however, such a conversion unit may be included in the modification unit.

Advantageously, the synthesis unit may use modified lattice filter reflection coefficients. In a preferred embodiment, both the analysis unit and the synthesis unit comprises a lattice filter. In this embodiment, no conversion from regular coefficients into reflection coefficients is necessary and the advantageous properties of lattice filters are fully utilized.

In an advantageous further embodiment of the present invention, the modification unit is arranged for modifying poles so as to warp the spectral envelope of the audio signal. Warping involves a non-linear transformation of the spectral envelope along its frequency axis, which transformation allows frequency spectrum modifications which cannot be achieved by (linear) scaling alone.

The modification unit may arranged for modifying poles without being arranged for interpolating lattice filter reflection coefficients. Accordingly, the present invention also provides a device for modifying an audio signal, the device comprising:

an analysis unit for analyzing the audio signal so as to produce a set of filter parameters and a residual signal, the set of filter parameters comprising poles and coefficients,

a modification unit for modifying one or more filter parameters so as to produce a modified set of filter parameters, and

a synthesis unit for synthesizing a modified audio signal using the modified set of filter parameters and the residual signal,

wherein the modification unit is arranged for modifying poles so as to warp the envelope of the audio signal.

If the device of the present invention provides warping, the modification unit is preferably arranged for replacing at least some poles (λ_{A}) with a modified pole (λ_{B}), where the modified pole is given by

$${λ}_{B} = \frac{μ + {λ}_{A}}{1 + μ \cdot {λ}_{A}} ,$$

and where μ is a warping parameter. It is noted that this warping procedure may also carried out by a device which provides no scaling, and that warping and scaling may be carried out independently.

In an advantageous further embodiment, the device of the present invention further comprises a signal adaptation unit for adapting the frequency and/or the phase of the residual signal. In this way, the pitch of the audio signal may be changed.

The present invention further provides a consumer device and an audio system comprising a device as defined above. A consumer device according to the present invention may be a mobile telephone device, a hearing aid, an electronic game and/or game console, a personal computer, a karaoke device, or another type of consumer device involving audio signals, in particular speech and/or voice signals. In addition, the present invention provides a set of filter parameters modified by the method or device defined above, and an audio signal modified by the method or device defined above.

The present invention will further be explained below with reference to exemplary embodiments illustrated in the accompanying drawings, in which:

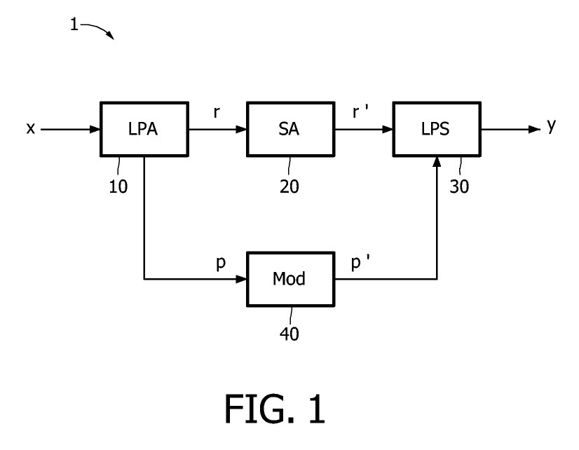

FIG. 1 schematically shows a parametric audio signal modification system according to the present invention.

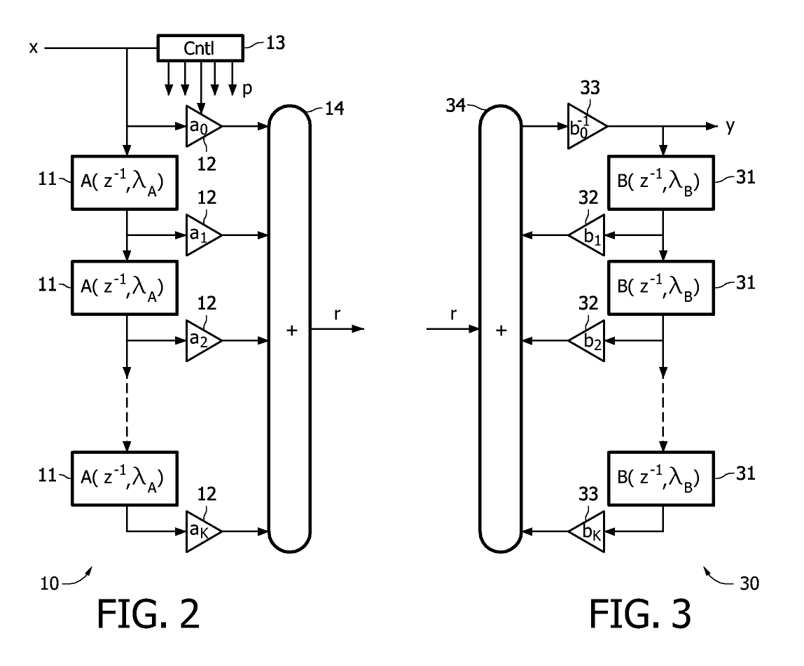

FIG. 2 schematically shows a first embodiment of a linear prediction analysis filter for use in the present invention.

FIG. 3 schematically shows a first embodiment of a linear prediction synthesis filter for use in the present invention.

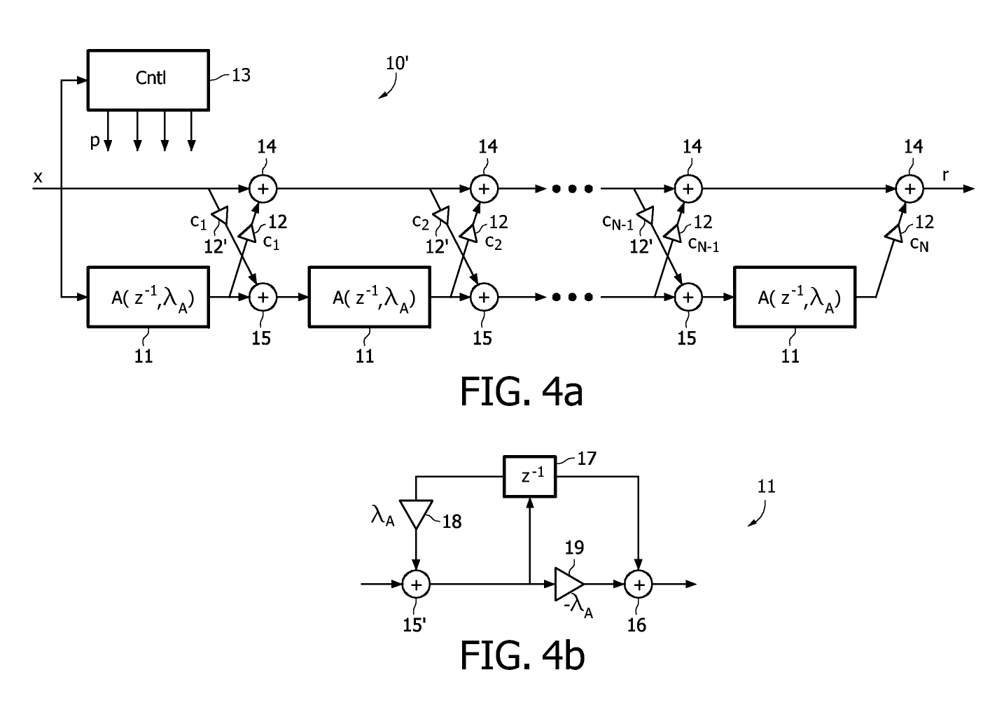

FIGS. 4a & 4b schematically show a second embodiment of a linear prediction analysis filter for use in the present invention.

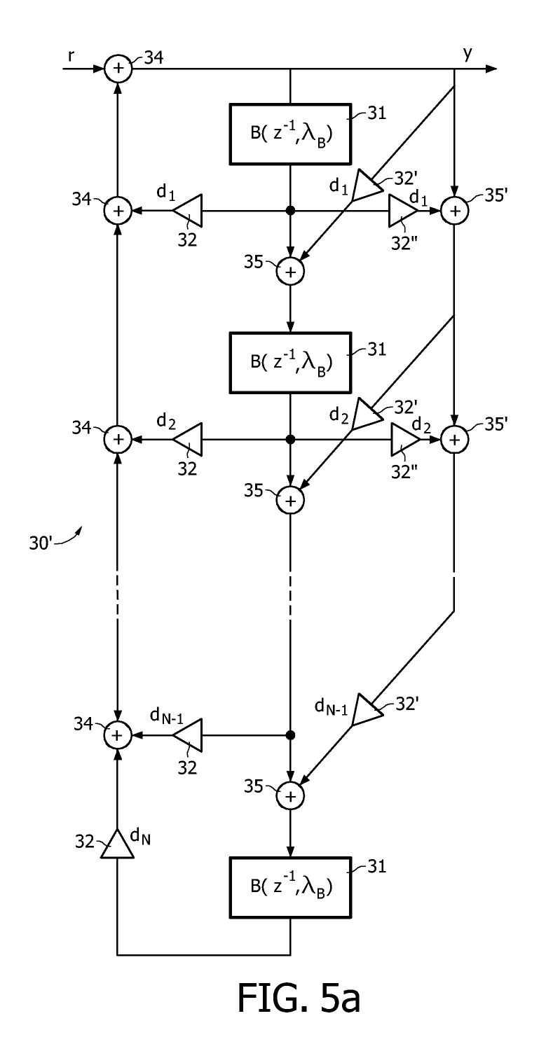

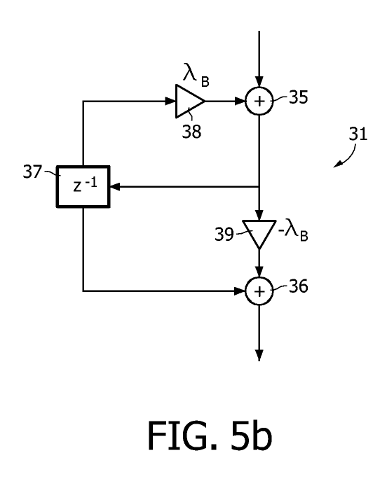

FIGS. 5a & 5b schematically show a second embodiment of a linear prediction synthesis filter for use in the present invention.

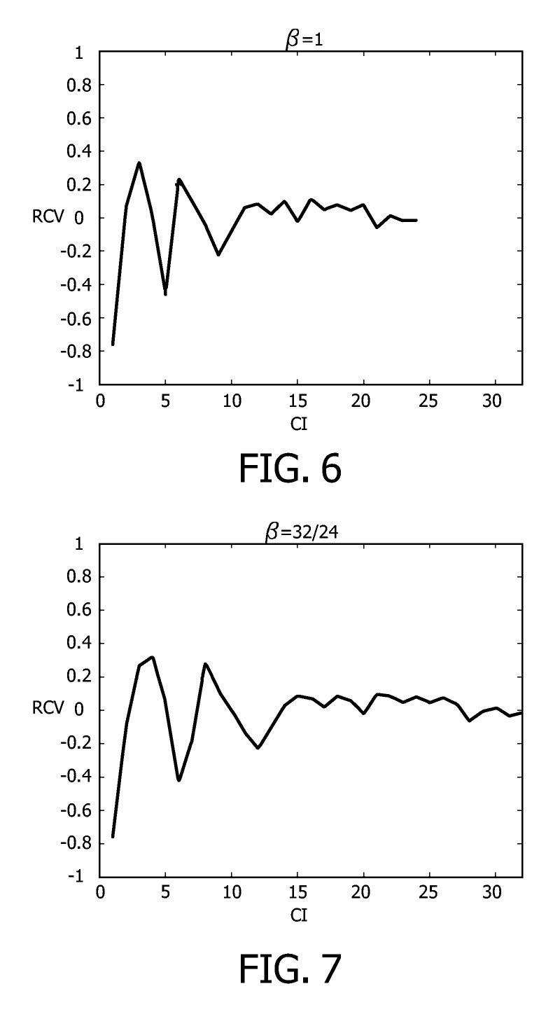

FIGS. 6 & 7 illustrate the scaling of lattice filter reflection coefficients according to the present invention.

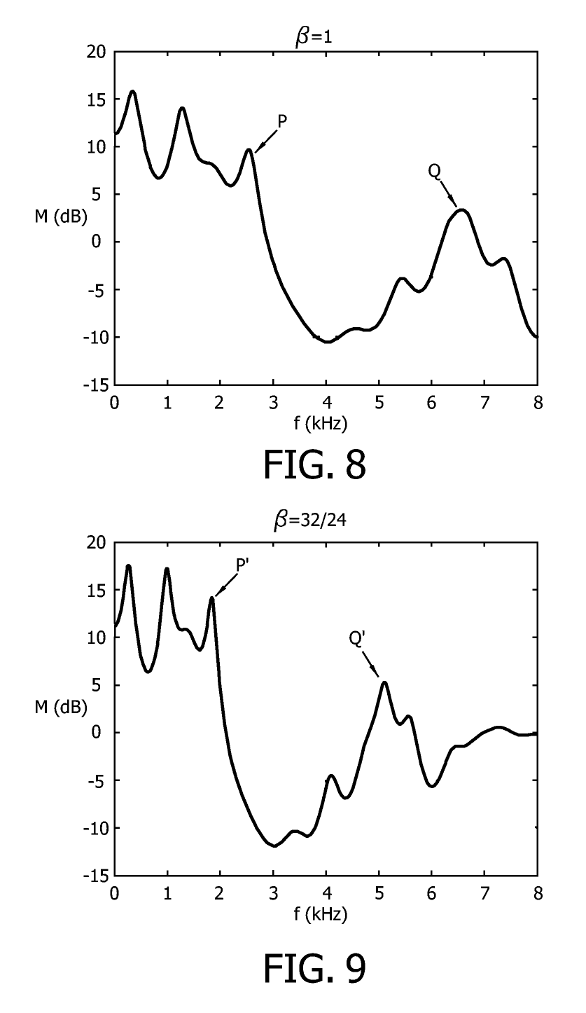

FIGS. 8 & 9 illustrate the scaling of the signal frequency spectrum according to the present invention.

The parametric audio signal modification system 1 shown merely by way of non-limiting example in FIG. 1 comprises a linear prediction analysis (LPA) unit 10, a signal adaptation (SA) unit 20, a linear prediction synthesis (LPS) unit 30 and a modification (Mod) unit 40. The signal adaptation unit 20 is optional and may be deleted if no adaptation of the residual signal corresponding with the audio signal is desired.

The structure of the parametric audio signal modification system 1 is known per se, however, in the system 1 illustrated in FIG. 1 the modification unit 40 has a novel function which will later be explained in more detail. In addition, the linear prediction analysis (LPA) unit 10 and the linear prediction synthesis (LPS) unit 30 preferably have a particular design which later will be explained in more detail with reference to FIGS. 4 and 5.

The system 1 of FIG. 1 receives an audio signal x, which may for example be a voice (speech) signal or a music signal, and outputs a modified audio signal y. The signal x is input to the linear prediction analysis (LPA) unit 10 which converts the signal into a sequence of (time-varying) prediction parameters p and a residual signal r. To this end, the linear prediction analysis unit 10 comprises a suitable linear prediction analysis filter or its equivalent. The prediction parameters p produced by the unit 10 are filter parameters which allow a suitable filter, in the example shown a linear prediction synthesis (LPS) filter contained in the linear prediction synthesis unit 30, to substantially reproduce the signal x in response to a suitable excitation signal. The residual signal r (or, after any pitch adaptation or other adaptation, the modified residual signal r′) serves here as the excitation signal.

The optional signal adaptation (SA) unit 20 allows for example the pitch (dominant frequency) of the audio signal x to be modified by modifying the residual signal r and producing a modified residual signal r′. Other parameters of the signal x may be modified using the further modification unit 40 which is arranged for modifying the prediction parameters p and producing modified prediction parameters p′. In the present invention, the signal adaptation (SA) unit 20 is not essential and may be omitted, in which case the modified (or adapted) residual signal r′ would be identical to the (original) residual signal r.

An example of a linear prediction analysis filter 10 is illustrated in FIG. 2. The exemplary filter 10 of FIG. 2 comprises filter units 11, weighting units 12, a control unit 13 and a combination unit 14. The input signal x is fed to both the control unit 13 and the first weighting unit 12. Each weighting unit 12 effectively multiplies the signal with its respective weight a₀, a₁, . . . aₖ and outputs a weighted signal which is fed to the combination unit 14. In the embodiment shown, the combination unit 14 adds its input signals to produce a combined output signal r. The weights aᵢ (i=0 . . . k) are determined by the control unit 13.

For speech (voice) applications, the filter 10 is preferably designed in such a way that it models the vocal tract, the output signal r resembling a vocal excitation signal which, when input to the vocal tract, produces a speech signal corresponding with the filter input signal x.

In the example of FIG. 2, each filter unit 11 has an all-pass transfer function A(z⁻¹, λ_{A}):

$$A ( {z}^{- 1} , {λ}_{A} ) = \frac{- {λ}_{A} + {z}^{- 1}}{1 - {λ}_{A} \cdot {z}^{- 1}} \qquad ( 1 )$$

with z⁻¹ representing a unit delay and λ_{A} being a transfer function parameter defining a pole of the filter. The pole λ_{A} may be determined by the control unit 13, or may be predetermined.

The control unit 13 determines the coefficients aᵢ and the pole λ_{A} in such a way that these parameters define the spectral envelope of the signal x, the residual signal r having a substantially “flat” (that is, constant) envelope. The coefficients aᵢ and the pole λ_{A} together form a set of parameters which is denoted p in FIG. 1. It is noted that a different set of parameters p may be produced for each signal time segment, for example for each frame.

The parameters aᵢ (i=0 . . . k) and λ_{A} of the filter 10 are fed to the modification unit 40 (FIG. 1) where they are modified. The modified parameters are output as parameters bᵢ (i=0 . . . k) and λ_{B}. The connections between the weighting units 12 and the modification unit 40 are not shown in FIG. 2 for the sake of clarity of the illustration.

It is noted that all signals are discrete time signals and could be written as x(n), y(n) and r(n) with n being the sample number. For the sake of brevity, however, these signals are denoted x, y and r respectively.

The parameters bᵢ (i=0 . . . k) of the linear prediction synthesis (LPS) filter 30 of FIG. 3 are also used as weighting coefficients. The filter 30 comprises filter units 31, weighting units 32 and 32′, and a combination unit 34. The weighting units 32 each have a parameter bᵢ (i=1 . . . k), while the weighting unit 32′ has a parameter b₀⁻¹. Those skilled in the art will understand that for b₀=a₀, bᵢ=−aᵢ/b₀ (for i=1 . . . m) and λ_{B}=λ_{A}, the synthesis filter 30 is the exact inverse of the analysis filter 10. It is noted that m may be different from k, in other words, the number of weighting units 32 and 32′ in the synthesis filter 30 is not necessarily equal to the number of weighting units 12 in the analysis filter 10.

The filter 30 receives a parameter set p′ from the modification unit 40 (see FIG. 1). The connections between the elements 31, 32 and 32′ of filter 30 and the modification unit 40 are not shown for the sake of clarity. The parameter set p′ comprises the coefficients bᵢ and the pole λ_{B}.

The combination unit 34, which is arranged for adding its input signals, receives the signal r produced by the filter 10 of FIG. 2 (it is noted that the signal r may be modified by a pitch adaptation unit 20 as illustrated in FIG. 1, in which case the combination unit 34 receives a signal r′) and the weighted filter signals produced by the weighting units 32. The combined output signal of the unit 34 is fed to the weighting unit 32′ having the weight (coefficient) b₀⁻¹. The output signal of the weighting unit 32′ is the filter output signal y.

In the example of FIG. 3, each filter unit 31 has a transfer function B(z⁻¹, λ_{B}):

$$B ( {z}^{- 1} , {λ}_{B} ) = \frac{- {λ}_{B} + {z}^{- 1}}{1 - {λ}_{B} \cdot {z}^{- 1}} \qquad ( 2 )$$

with z⁻¹ representing a unit delay and λ_{B} being a transfer function parameter or pole. The parameter λ_{B} is a modified version of the corresponding parameter λ_{A} of the filter 10 of FIG. 2, the modification resulting in a non-linear scaling (that is, a warping) of the spectral envelope of the signal y relative to the input signal x.

The modification of the signal parameters is carried out as follows. Assume that a scaling of the frequency axis is required of 32/24. Accordingly, the scaling factor X equals 32/24=1.33 (it will be understood that a scaling factor β equal to 1 amounts to no scaling).

An autocorrelation function can be determined from the impulse response of the synthesis filter. This autocorrelation function can be re-sampled. From the re-sampled autocorrelation function, the new coefficients of the synthesis filter can be determined using techniques which are well known to those skilled in the art. Typically, this is achieved by solving the normal equations associated with the linear predictor involved. However, solving these equations may require extensive calculations. By way of alternative, therefore, the present invention proposes to modify the filter coefficients, in particular the reflection coefficients associated with these filter coefficients.

The present inventors have found that lattice filters are particularly suitable for implementing the present invention as the reflection coefficients are directly available in lattice filters. This eliminates the need of converting the regular filter coefficients aᵢ into reflection coefficients, and the conversion of the modified reflection coefficients into the modified regular filter coefficients bᵢ.

A lattice filter embodiment of a linear prediction analysis (LPA) filter (10 in FIG. 2) is schematically illustrated in FIG. 4a.

The filter 10′ comprises filter units 11, weighting units 12 and 12′, a control unit 13 and combination units 14 and 15. The filter units 11 each have a filter transfer function A(z⁻¹, λ_{A}), as in the conventional filter 10 of FIG. 2. The weighting units 12 each have an associated weights (weighting parameters) cᵢ (i=1 . . . N), each of which is equal to the i^{th} reflection coefficient. The weighting units 12 also have weights cᵢ. The control unit 13 derives the parameters λ_{A} and cᵢ from the input signal x, as in the embodiment of FIG. 2.

The weighting units 12 feed the output signals of the filter units 11 to the combination units 14 to produce a combined output signal r. As the filter 10′ is a lattice filter, it has so-called reflection coefficients that are constituted by the weights cᵢ of the weighting units 12′. These units 12′ feed the input signal x (in the first stage) or an intermediate signal (in subsequent stages) to the combination units 15, which combine these weighted signals with the output signal of the respective filter unit 11 before feeding this output signal to the next filter unit 11.

The filter units 11 of the filter 10′ are illustrated in more detail in FIG. 4b. The filter unit 11 is shown to comprise a first combination unit 15′ (which may be identical to the unit 15 shown in FIG. 4a or may be constituted by a separate unit), a second combination unit 16, a delay unit 17 and weighting units 18 and 19. The weighting units 18 and 19 have weighting parameters λ_{A} and −λ_{A} respectively.

The lattice filter 10′ has the advantage of being eminently suitable for scaling the spectral envelope of the input audio signal as the (reflection) coefficient of the filter are directly accessible.

A lattice filter embodiment of a linear prediction synthesis (LPS) filter (30 in FIG. 3) is schematically illustrated in FIG. 5a. The lattice filter 30′ comprises filter units 31, weighting units 32, 32′ and 32″, and combination units 34, 34′ and 35. The weighting units 32, 32′ and 32″ each have an associated weighting parameter dᵢ (i=1 . . . N). The combination units 34, which are arranged for adding its input signals, receive the signal r produced by the filter 10 of FIG. 2 (or a corresponding pitch modified signal r′) and the weighted filter signals produced by the weighting units 32. The combined output signal of the units 34 is the filter output signal y.

Each filter unit 31 has a transfer function B(z⁻¹, λ_{B}), with z⁻¹ representing a unit delay and λ_{B} being a transfer function parameter. The parameter (or pole) λ_{B} is a modified version of the corresponding parameter λ_{A} of the filter 10 of FIG. 2, the modification resulting in a non-linear frequency scaling (warping) of the spectral envelope of the signal y relative to the spectral envelope of the signal x.

The filter units 31 of the filter 30′ are illustrated in more detail in FIG. 5b. The filter unit 31 is shown to comprise a first combination unit 35′ (which may be identical to the unit 35 shown in FIG. 5a or may be constituted by a separate unit), a second combination unit 36, a delay unit 37 and weighting units 38 and 39. The weighting units 38 and 39 have weighting parameters λ_{B} and −λ_{B} respectively.

A (linear or proportional) scaling of the spectral envelope can be achieved by a suitable transformation of the parameters. More in particular, a frequency mapping may be achieved according to the formula:

f′=β·fₛ (3)

where f′ is the modified frequency, β is a scaling factor and f is the original frequency. Any modified frequency values may be determined by scaling the (reflection) coefficients of the filters along their axis using the same scaling factor β.

For example, if the frequency axis is to be scaled by a scaling factor of 0.5 (that is, β=0.5), then the filter coefficients are scaled using this scaling factor 0.5. The new 1^{st} coefficient, for example, obtains the value of the original 2^{nd} coefficient, while the new 2^{nd} coefficient obtains the value of the original 4^{th} coefficient. In this example, the number of coefficients is also halved.

For other values of β, for example β=0.3 or β=2.0, coefficients take on values from intermediate positions. When β=0.3, for example, new coefficient no. 3 takes on the value of old coefficient no. 10 (10×0.3=3) but new coefficient no. 2 assumes the value corresponding with (non-existent) original coefficient no. 6.667. These intermediate values are determined using interpolation techniques known per se, such as Lagrange interpolation. This will later be illustrated with reference to FIGS. 6 and 7.

A non-linear scaling or warping of the spectral envelope can be achieved by a suitable transformation of the parameters. More in particular, a frequency mapping may be achieved that can be described by the formula:

$${θ}^{′} = θ + 2 \cdot arctan ( \frac{μ \cdot sin ( θ )}{1 - μ \cdot cos ( θ )} ) , \qquad ( 4 )$$

where θ is the frequency, normalized with respect to the sampling frequency fₛ:

θ=2π·f/fₛ. (5)

This frequency mapping (that is, non-linear scaling of the frequency axis) is obtained when the filter parameters λ_{A} are transformed according to:

$${λ}_{B} = \frac{μ + {λ}_{A}}{1 + μ \cdot {λ}_{A}} \qquad ( 6 )$$

where μ is the warping parameter with −1<μ<1. It can be seen that for μ=0, no warping occurs as λ_{B}=λ_{A}. Using formulae (3), (4) and (5), a desired linear and/or non-linear scaling of the frequency axis can be obtained for given values of β and μ.

From formula (6) it is clear that linear prediction synthesis filters based on all-pass sections, such as the filters 30 and 30′, are advantageous as the filters always have the same structure, regardless of the chosen warping factor. Only the parameter λ_{B} of the all-pass sections changes as a function of the warping parameter μ.

The effects of scaling are illustrated in FIGS. 6-9. FIG. 6 shows exemplary reflection coefficient values (RCV) as a function of the coefficient index (CI) denoted i in FIGS. 4a and 5a. The reflection coefficient values of FIG. 6 represent the coefficients dᵢ of the filter 30′ shown in FIG. 5a in the absence of scaling: the scaling factor β equals 1 and dᵢ=cᵢ for all values of i. FIG. 7 shows the same coefficients when scaled with a scaling factor β equal to 32/24=1.333. It can be seen that the original coefficient values have been redistributed, thus creating a new set of coefficients. For example, the value of original coefficient no. 12 has been assigned to new coefficient no. 16 (as 16=12×32/24), while new coefficient no. 15 has received the interpolated value corresponding with non-existent original coefficient no. 11.25 (as 15=11.25×32/24). In addition, the number of coefficients has increased form 24 to 32.

In FIG. 8, the magnitude (M) of the amplitude spectrum of the synthesis filter is shown, in decibels (dB), as a function of the frequency (f) in the absence of scaling: β=1. After scaling with a scaling factor β=32/24, the frequency spectrum has been compressed, the peak previously located around 2.5 kHz (P) now being located around 1.9 kHz (P′), and the peak originally located at approximately 6.5 kHz (Q) now being located around 5.0 kHz (Q′), as illustrated in FIGS. 8 & 9. It can therefore be seen that the present invention allows a very effective scaling of the spectral envelope of audio signals.

It is noted that the merely exemplary spectral envelope of FIG. 8 has been extrapolated to produce the spectral envelope of FIG. 9. This extrapolation of the spectral envelope is the result of the scaling factor β being larger than 1 and is achieved without extrapolating the coefficients (FIGS. 6 & 7). Instead, some coefficient values are the result of an interpolation.

The present invention is based upon the insight that linear and non-linear scaling operations of an audio signal, such as a speech signal, can be effected by modifying only two control parameters. The present invention benefits from the further insights that the reflection coefficients of lattice filters are particularly suitable for audio signal scaling, and that warping may be carried out effectively using a synthesis filter based on all-pass sections.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A method of modifying an audio signal, the method comprising:
analyzing the audio signal to produce a set of filter parameters and a residual signal, the set of filter parameters comprising coefficients,
modifying one or more of the filter parameters to produce a modified set of filter parameters, and
synthesizing a modified audio signal using the modified set of filter parameters and the residual signal, wherein lattice filter reflection coefficients are interpolated to scale an envelope of the audio signal.

2. The method according to claim 1, further comprising producing lattice filter reflection coefficients.

3. The method according to claim 1, further comprising using modified lattice filter reflection coefficients.

4. (canceled)

5. A method of modifying an audio signal, the method comprising:
analyzing the audio signal to produce a set of filter parameters and a residual signal, the set of filter parameters comprising coefficients,
modifying one or more of the filter parameters to produce a modified set of filter parameters, and
synthesizing a modified audio signal using the modified set of filter parameters and the residual signal, wherein poles are modified to warp a spectral envelope of the audio signal.

6. (canceled)

7. The method according to claim 1, further comprising modifying the frequency and/or the phase of the residual signal.

8. (canceled)

9. (canceled)

10. A device for modifying an audio signal, the device comprising:
an analysis unit for analyzing the audio signal to produce a set of filter parameters and a residual signal, the set of filter parameters comprising coefficients (a; c),
a modification unit for modifying one or more of the filter parameters to produce a modified set of filter parameters, and
a synthesis unit for synthesizing a modified audio signal using the modified set of filter parameters and the residual signal, wherein the modification unit (40) is arranged for interpolating lattice filter reflection coefficients to scale an envelope of the audio signal.

11. The device according to claim 10, wherein analysis unit is arranged for producing lattice filter reflection coefficients.

12. The device according to claim 10, wherein the synthesis unit uses modified lattice filter reflection coefficients.

13. The device according to claim 10, wherein the analysis unit and the synthesis unit comprise a lattice filter.

14. (canceled)

15. A device for modifying an audio signal, the device comprising:
an analysis unit for analyzing the audio signal to produce a set of filter parameters and a residual signal, the set of filter parameters comprising coefficients,
a modification unit for modifying one or more of the filter parameters to produce a modified set of filter parameters, and
a synthesis unit for synthesizing a modified audio signal using the modified set of filter parameters and the residual signal, wherein the modification unit is arranged for modifying poles to warp an envelope of the audio signal.

16. (canceled)

17. The device according to claim 15, further comprising a signal adaptation unit for adapting the frequency and/or the phase of the residual signal.

18. (canceled)
